(19) United States
(12) Patent Application Publication
(10) Pub. No.: US 2011/0309210 A1
(43) Pub. Date: Dec. 22, 2011

(54) BAG SUPPORT

(75) Inventor: John Richard Muse, Douglasville, GA (US)

(73) Assignee: PRATT INDUSTRIES (U.S.A.), INC., Conyers, GA (US)

(21) Appl. No.: 13/164,481

(22) Filed: Jun. 20, 2011

Related U.S. Application Data
(60) Provisional application No. 61/357,518, filed on Jun. 22, 2010.

(51) Int. Cl. B65B 67/12; B23P 11/00

(52) U.S. Cl. 248/99; 29/428

(57) ABSTRACT

Disclosed is a bag support including at least one base, the at least one base being about flat and extending the length of the bag support; and two sides, each adaptable to be oriented at an angle with respect to the base, each side including an about flat flared portion, an about flat funneling portion, and an about flat insert portion, there being a linear distance between the flared portions of the each side, there being a linear distance between the insert portions of the each side, the linear distance between the flared portions being greater than the linear distance between the insert portions, wherein the funneling portion of each side connects the flared portion of each side to the insert portion of each side and wherein each side is connected to each at least one base.

### CROSS-REFERENCE TO RELATED APPLICATIONS

This application claims the benefit of U.S. Provisional Application 61/357,518 filed on Jun. 22, 2010, which is hereby incorporated herein in its entirety by reference.

### FIELD

This disclosure relates to refuse gathering and bagging. Specifically, this disclosure relates to devices to facilitate refuse gather and bagging.

### BACKGROUND

To be discarded, refuse is typically bagged. Particularly with lawn refuse, filling a refuse bag may become difficult when the refuse itself is non-solid. For example, leaves, needles, dirt, and sticks tend not to hold together when a user attempts to place such items in a bag. Further, a user may wish not to touch such refuse with his or her hands to accomplish bagging. However, if a user attempts to use a tool to place refuse into a refuse bag, the refuse bag is subject to collapsing.

### SUMMARY

A bag support is disclosed having an end for holding open a refuse bag and an end to facilitate filling the refuse bag. The bag support is oriented to allow the bag support and refuse bag together to rest against the ground while holding the refuse bag open, thereby allowing a user to utilize a sweeping tool to fill the refuse bag.

### DESCRIPTION OF THE FIGURES

The features and components of the following figures are illustrated to emphasize the general principles of the present disclosure and are not necessarily drawn to scale. Corresponding features and components throughout the figures may be designated by matching reference characters for the sake of consistency and clarity.

FIG. 1 is a perspective view of a bag support for holding and filling a refuse bag.

FIG. 2 is a top view of a blank of the bag support of FIG. 1.

FIG. 3 is a perspective view of the bag support of FIG. 2 with the left side and the right side bent.

FIG. 4 is a perspective view of the bag support of FIG. 2 with the left side bent.

FIG. 5 is a close-up view of a user inserting a funnel stiffener into a funnel stiffener slot of the bag support of FIG. 2.

FIG. 6 is a perspective view of the bag support of FIG. 4 wherein the left side is further bent.

FIG. 7 is a perspective view a user inserting an insert stiffener into an insert stiffener slot of the bag support of FIG. 2.

FIG. 8 is a perspective view of the bag support of FIG. 6 wherein an insert stiffener is bent and inserted into an insert stiffener slot.

FIG. 9 is a perspective view of the bag support of FIG. 1 displaying the bottom and right outside of the bag support.

FIG. 10 is a perspective view of the bag support of FIG. 1 viewed from the back.

FIG. 11 is a perspective view of the bag support of FIG. 1 showing the bottom and bag of the bag support.

FIG. 12 is a perspective view of a user assembling the bag support of FIG. 1, wherein the user bends the left side.

FIG. 13 is a perspective view of a user assembling the bag support of FIG. 1, wherein the user inserts the insert stiffener into the insert stiffener slot.

FIG. 14 is a perspective view of a user assembling the bag support of FIG. 1, wherein the user bends the right side and inserts the insert stiffener into the insert stiffener slot.

FIG. 15 is a perspective view of the bag support of FIG. 1 in use with a plastic refuse bag.

FIG. 16 is a perspective view of the bag support of FIG. 1 in use with a paper refuse bag.

### DETAILED DESCRIPTION

Disclosed is a support for holding open a refuse bag. It should be emphasized that the embodiments described herein are merely possible examples of implementations, merely set forth for a clear understanding of the principles of the present disclosure. Many variations and modifications may be made to the described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

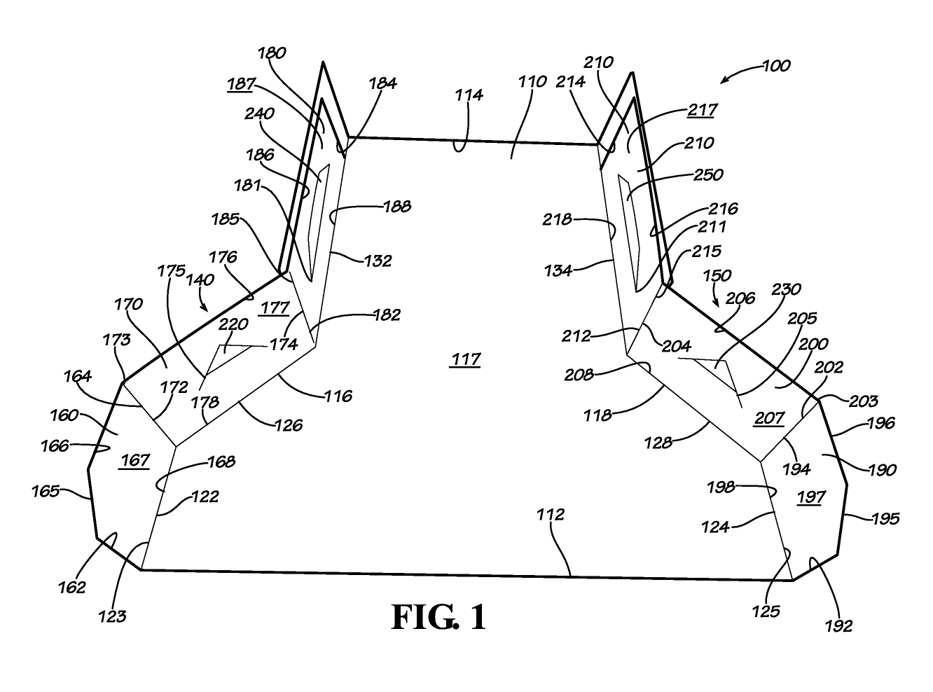

A bag support 100 is disclosed for use with a refuse bag to facilitate holding open and filling of the refuse bag. FIG. 1 shows the bag support 100 in a final shape. As seen in FIG. 1, the bag support 100 includes a base 110 that generally forms the shape of the bag support 100. The base 110 includes a front end 112, a back end 114, an inner surface 117, and an outer surface 119 (not shown). The base 110 includes a left end 116 and a right end 118. Directional references such as “up,” “down,” “top,” bottom,” “left,” and “right,” among others, are intended to refer to the orientation as shown and described in FIG. 1. Such modifiers are used for reference only and are not intended to limit the disclosure. Like features in other embodiments may be included with directionally distinct identifiers. Although one base 110 is included in the current embodiment, the bag support 100 could include two bases 110, wherein one base 110 forms a top and another base 110 forms a bottom. Other base configurations are also possible, including multiple base sections joined for together to for one base 110 or multiple bases 110 stacked a distance apart from each other to provide narrow gaps between them, among others.

Each of the left end 116 and right end 118 includes a flared end portion 122,124, a funneling end portion 126,128, and an insert end portion 132,134, respectively. The flared end portions 122,124 are about parallel to each other in the current embodiment, although they need not be. The insert end portions 132,134 are about parallel to each other in the current embodiment, although they need not be. Also, the flared end portions 122,124 are about parallel to the insert end portions 132,134 in the current embodiment, although they need not be. The funneling end portions 126,128 are oriented about forty-five degrees with respect to the parallel portions. Each funneling end portion 126,128 is oriented about forty-five degrees in the reverse angle of the other funneling end portion 126,128 so that the funneling end portions 126,128 are oriented ninety degrees with respect to each other. All angles cited in this disclosure are for illustrative purposes only and are not intended to limit the scope of the disclosure. Other angular configurations are also possible without departing from the scope of the disclosure.

Connected to the base 110 are a left side 140 and a right side 150. In some embodiments, the left side 140 and right side 150 oppose each other, thereby defining opposing sides. Each side includes three portions. The left side 140 includes a flared portion 160, a funneling portion 170, and an insert portion 180. The right side 150 includes a flared portion 190, a funneling portion 200, and an insert portion 210. Flared portion 160 has front end 162, back end 164, outer end 166, inner end 168, inner surface 167, and outer surface 169 (not shown). An angled edge 165 connects the front end 162 and the outer end 166. Likewise, flared portion 190 has front end 192, back end 194, outer end 196, inner end 198, inner surface 197, and outer surface 199 (not shown), as well as an angled edge 195 connecting the front end 192 and the outer end 196. In the current embodiment, the left side 140 and right side 150 are adapted at approximately a ninety degree angle with respect to the base 110. However, other angular configurations are possible and should be considered as included in this disclosure.

The sides 140,150 are directly connected to the base 110 only by the flared portions 160,190. Inner ends 168,198 connect to flared end portions 122,124 by bend lines 123,125, respectively. Bend lines to which this disclosure refers are designed as weakened regions and may include a crease, a perforation, a series of perforations, or another arrangement to weaken the area of the bend line. In the current embodiment, bend lines are creases. All connections to which this disclosure refers may be any connection sufficient to hold together the elements to be connected, including an integrated construction, glue, a notched end, or other types of connecting means. Moreover, although hinged or bendable connections are disclosed in the current embodiment, non-hinged or non-bendable connections are considered included in the disclosure, and the disclosure of a bendable or hinged connection should not be considered limiting on the disclosure. Although other portions of the sides 140,150 contact the base 110, they are not directly connected in the current embodiment. Such portions may be directly connected to the base 110 in other embodiments.

Funneling portion 170 has front end 172, back end 174, outer end 176, and inner end 178. Funneling portion 170 is connected to flared portion 160 by bend line 173, which extends between front end 172 and back end 164. Likewise, funneling portion 200 has front end 202, back end 204, outer end 206, and inner end 208 Funneling portion 200 is connected to flared portion 160 by bend line 203, which extends between front end 202 and back end 194 Funneling portion 170 includes inner surface 177 and outer surface 179 (not shown) Funneling portion 200 includes inner surface 207 and outer surface 209 (not shown) Funneling portion 170 also includes a funnel stiffener slot 175, and funneling portion 200 includes a funnel stiffener slot 205. A funnel stiffener 220 is shown extended through the funnel stiffener slot 175, and a funnel stiffener 230 is shown extended through the funnel stiffener slot 205.

Insert portion 180 includes a front end 182, a back end 184, an outer end 186, an inner end 188, an inner surface 187, and an outer surface 189 (not shown). Insert portion 210 includes a front end 212, a back end 214, an outer end 216, an inner end 218, an inner surface 217, and an outer surface 219 (not shown). The insert portion 180 includes an insert stiffener slot 181, and the insert portion 210 includes an insert stiffener slot 211. An insert stiffener 240 is shown protruding through the insert stiffener slot 181. Likewise, an insert stiffener 250 is shown protruding through the insert stiffener slot 211. Insert portion 180 is connected to funneling portion 170 by bend line 185 which extends between back end 174 and front end 182. Insert portion 210 is connected to funneling portion 200 by bend line 215 which extends between back end 204 and front end 212. The funnel shape of FIG. 1 should be considered but one embodiment of the bag support 100, and other arrangements of funnel shapes may be obvious to one of skill in the art. For example, the insert portions 180,210 may be tapered or otherwise unparallel in various embodiments. In another example, the flared portions 160,190 and flared end portions 122,124 may be removed, removable, not included, or altered in various embodiments. As such, the funnel shape of FIG. 1 represents but one possible funnel shape among many.

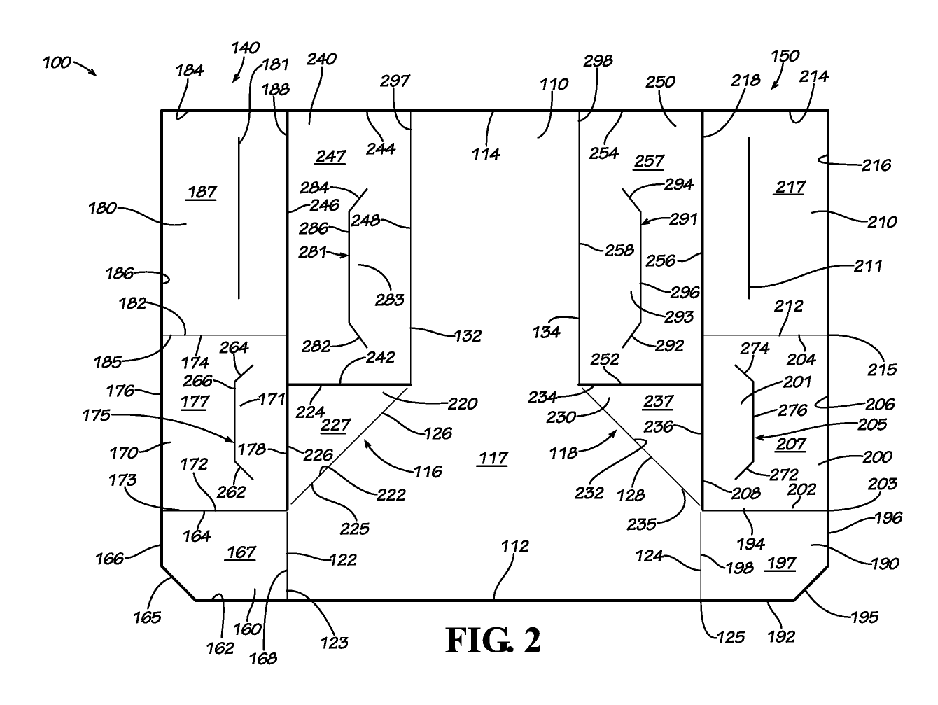

FIG. 2 displays the bag support 100 in a flattened, blank arrangement. Because the bag support 100 is formable from cardboard blanks, a flattened arrangement can be desirable for shipping and storage. The view of FIG. 2 is a top view of the cardboard blank after cutting. It should be noted that the material choices may change from cardboard. In the event of such a material change, the description provided in this disclosure may be inaccurate for that particular embodiment. To the extent that a material change alters steps or features described in this disclosure, such a change is intended to be included as an obvious variant of the presently described embodiment.

Viewable in FIG. 2, the funnel stiffeners 220,230 can be seen Funnel stiffener 220 has a back end 224, an outer end 226, a slanted end 222, an inner surface 227, and an outer surface 229 (not shown) Funnel stiffener 230 has a back end 234, an outer end 236, a slanted end 232, an inner surface 237, and an outer surface 239 (not shown). Each funnel stiffener 220,230 is about triangular in shape. The funnel stiffeners 220,230 are connected only to the base 110 Funnel stiffener 220 is connected to the base 110 along a bend line 225 which extends between slanted end 222 and funneling end portion 126 of left end 116 Funnel stiffener 230 is connected to the base 110 along a bend line 235 which extends between slanted end 232 and funneling end portion 128 of right end 118. None of back end 224, outer end 226, back end 234, or outer end 236 are connected to any other features of the bag support 100 in the current embodiment of the blank.

As can be seen in FIG. 2, funnel stiffener slot 175 includes a front portion 262, a back portion 264, and a connecting portion 266. The front portion 262 is angled at approximately a forty-five degree angle with respect to the ends (front end 172, back end 174, outer end 176, and inner end 178) of the funneling portion 170. The back portion 264 is angled at a forty-five degree angle with respect to the ends (172,174,176,178) of the funneling portion 170 and at a ninety degree angle with respect to the front portion 262. The connecting portion 266 is parallel to outer end 176 and inner end 178 and connects the front portion 262 with the back portion 264. Altogether, the front portion 262, back portion 264, and connecting portion 266 make up one slot 175 such that a flexible portion 171 that may flex outwardly or inwardly with respect to the funneling portion 170 of the side 140 is created within the confines of the slot 175. The flexure of the flexible portion 171 is determined by the material properties of the bag support 100. In some embodiments, the flexible portion 171 may be aided by a bend line or a hinge to allow its flexure more easily.

Similarly, funnel stiffener slot 205 includes a front portion 272, a back portion 274, and a connecting portion 276. The front portion 272 is angled at approximately a forty-five degree angle with respect to the ends (front end 202, back end 204, outer end 206, and inner end 208) of the funneling portion 200. The back portion 274 is angled at a forty-five degree angle with respect to the ends (202,204,206,208) of the funneling portion 200 and at a ninety degree angle with respect to the front portion 272. The connecting portion 276 is parallel to outer end 206 and inner end 208 and connects the front portion 272 with the back portion 274. Altogether, the front portion 272, back portion 274, and connecting portion 276 make up one slot 205 such that a flexible portion 201 that may flex outwardly or inwardly with respect to the funneling portion 200 of the side 150 is created within the confines of the slot 205. The flexure of the flexible portion 201 is determined by the material properties of the bag support 100. In some embodiments, the flexible portion 201 may be aided by a bend line or a hinge to allow its flexure more easily.

The insert stiffener 240 includes a front end 242, a back end 244, an outer end 246, an inner end 248, an inner surface 247, and an outer surface 249 (not shown). A tab slot 281 is formed in the insert stiffener 240. The tab slot 281 includes a front portion 282, a back portion 284, and a connecting portion 286. Similar to the stiffener slot 175, the front portion 282 is angled at approximately a forty-five degree angle with respect to the ends (front end 242, back end 244, outer end 246, inner end 248) of the insert stiffener 240. Likewise, the back portion 284 is angled at approximately a forty-five degree angle with respect to the ends (242,244,246,248) and at a ninety degree angle with respect to the front portion 282. The connecting portion 286 is parallel to outer end 246 and inner end 248. The front portion 282, back portion 284, and connecting portion 286 make up one tab slot 281 such that a flexible tab 283 that may flex outwardly or inwardly with respect to the insert stiffener 240 is created within the confines of the tab slot 281. The flexure of the flexible tab 283 is dependent on the material properties of the bag support 100. In some embodiments, the flexible tab 283 may be aided by a bend line or a hinge to allow its flexure more easily.

Similarly, the insert stiffener 250 includes a front end 252, a back end 254, an outer end 256, an inner end 258, an inner surface 257, and an outer surface 259 (not shown). A tab slot 291 is formed in the insert stiffener 250. The tab slot 291 includes a front portion 292, a back portion 294, and a connecting portion 296. Similar to the stiffener slot 205, the front portion 292 is angled at approximately a forty-five degree angle with respect to the ends (front end 252, back end 254, outer end 256, inner end 258) of the insert stiffener 250. Likewise, the back portion 294 is angled at approximately a forty-five degree angle with respect to the ends (252,254,256,258) and at a ninety degree angle with respect to the front portion 292. The connecting portion 296 is parallel to outer end 256 and inner end 258. The front portion 292, back portion 294, and connecting portion 296 make up one tab slot 291 such that a flexible tab 293 that may flex outwardly or inwardly with respect to the insert stiffener 250 is created within the confines of the tab slot 291. The flexure of the flexible tab 293 is dependent on the material properties of the bag support 100. In some embodiments, the flexible tab 293 may be aided by a bend line or a hinge to allow its flexure more easily.

The slots, tabs, and flexible portions in the current embodiment are illustrative only. A particular embodiment need not implement any specific configuration of slots, tabs, or flexible portions. Moreover, the shape and location of slots, tabs, and flexible portions may vary from one embodiment to another. In some embodiments, the connection desired by use of a slot, tab, or flexible portion may not include a slot, tab, or flexible portion, but instead could include adhesives, mechanical fasteners, or other means of attachment.

Insert stiffener 240 is connected only to the base 110. In the current embodiment, the connection between side 240 and base 110 is a bend line 297 extending between inner end 248 and the insert end portion 132 of the left end 116. Similarly, insert stiffener 250 is connected only to the base 110. In the current embodiment, the connection between insert stiffener 250 and base 110 is a bend line 298 extending between inner end 258 and the insert end portion 134 of the right end 118.

As noted previously, some parts of the bag support 100 are not connected to other parts. Insert stiffeners 240 and 250 are connected only to the base 110 at bend lines 297 and 298, respectively. Funnel stiffeners 220 and 230 are connected only to the base 110 at bend lines 225 and 235, respectively. Flared portions 160 and 190 are connected to the base 110 at bend lines 123 and 125, respectively. Flared portions 160 and 190 are connected to funneling portions 170 and 200 along bend lines 173 and 203, respectively Funneling portions 170 and 200 are connected to flared portions 160 and 190 along bend lines 173 and 203 (as previously described) and also to insert portions 180 and 210 along bend lines 185 and 215, respectively. All other lines, ends, and sides are disconnected in the current embodiment. Thus, there is no connection along inner end 188; inner end 178; outer end 226; back end 224; front end 242; outer end 246; inner end 218; inner end 208; outer end 236; back end 234; front end 252; or, outer end 256. The configuration allows for multiple portions and features of the bag support 100 to be bent from the blank of FIG. 2 into the final shape of FIG. 1. The current embodiment is intended to represent only one embodiment. Other embodiments may include bend lines and connections along other lines, or may include different configurations altogether, without departing from the spirit of the disclosure.

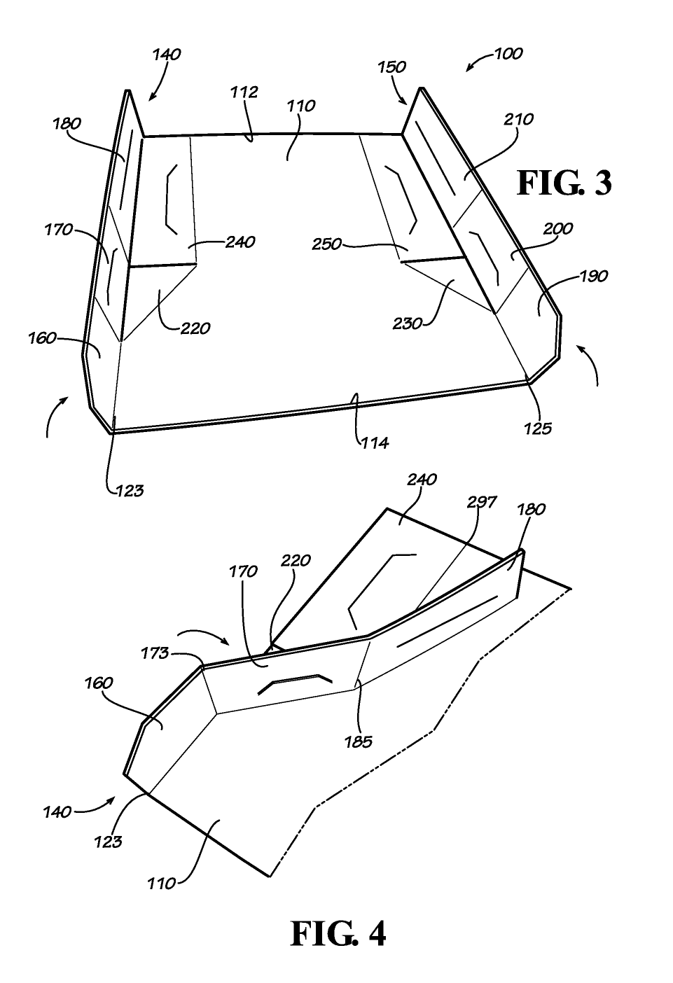

To form the bag support 100 from the blank arrangement of FIG. 2 to the final shape of FIG. 1, a user follows several steps. First, the left side 140 is folded along bend line 123 and the right side 150 is folded along bend line 125, as shown in FIG. 3. FIG. 4 shows the left side 140 bent along bend line 173. A similar bend occurs for the right side 150 along bend line 203.

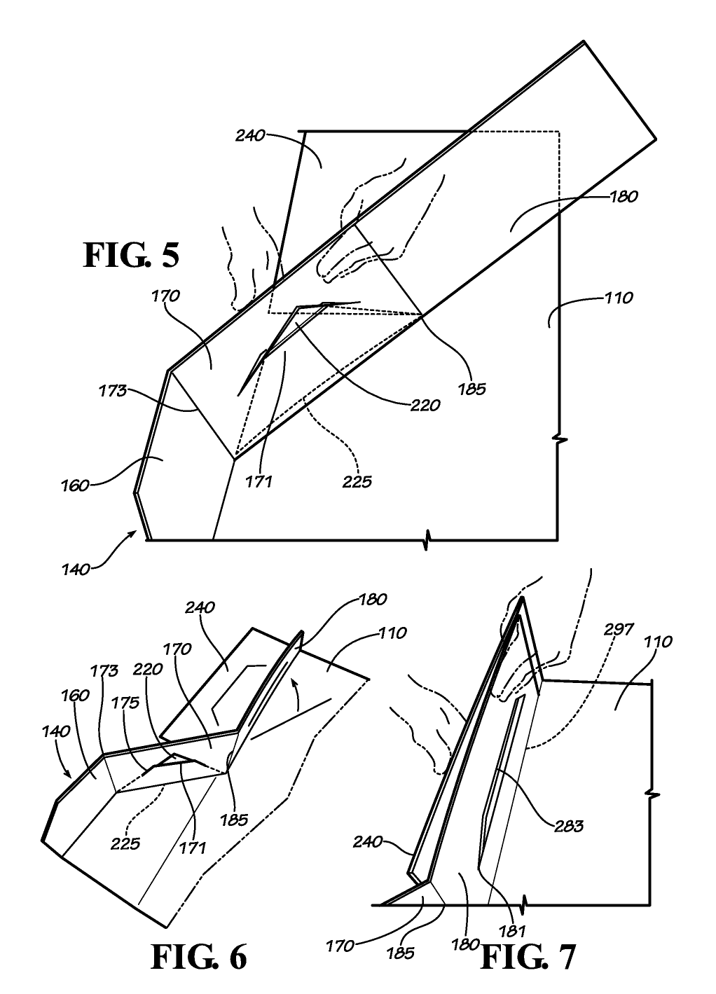

As shown in FIG. 5, the left side 140 is bent inwardly along bend line 173 Funnel stiffener 220 is bent upwardly along bend line 225. The funnel stiffener slot 175 is opened by bending flexible portion 171 inward from funneling panel 170 Funnel stiffener 220 is inserted into funnel stiffener slot 175. Although not shown in FIG. 5, the same process occurs on the right side 150. The right side 150 is bent inwardly along bend line 203 Funnel stiffener 230 is bent upwardly along bend line 235. The funnel stiffener slot 205 is opened by bending flexible portion 201 inward from funneling panel 200 Funnel stiffener 230 is inserted into funnel stiffener slot 205.

FIG. 6 shows the left side 140 further bent along bend line 185 so that insert portion 180 is bent with respect to the rest of the left side 140. The funnel stiffener 220 is shown to be inserted into the funnel stiffener slot 175. The same process occurs for the right side 150, wherein insert portion 210 is bent along bend line 215 thereby being bent with respect to the rest of the right side 150 after the funnel stiffener 230 is inserted into the funnel stiffener slot 205.

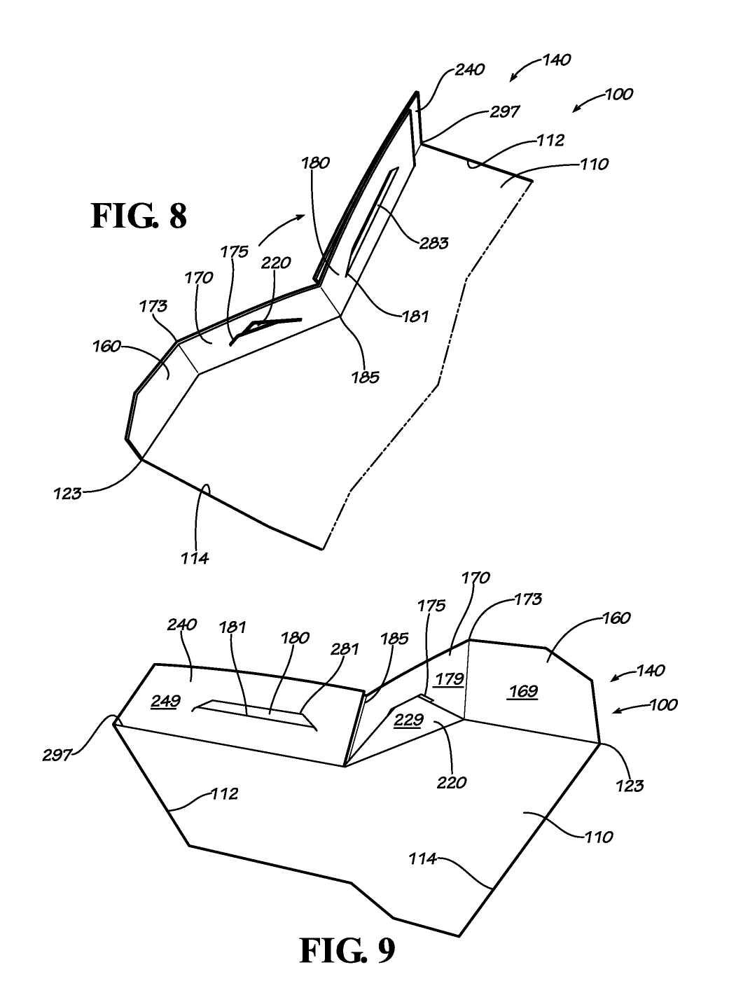

Next, the insert stiffener 240 is bent along bend line 297 and inserted into the insert stiffener slot 181 in the insert portion 180, as seen in FIG. 7. To achieve the insertion, the flexible tab 283 is flexed inwardly from the insert stiffener 240. Natural flexure in the material allows the insert stiffener slot 181 to open. The flexible tab 283 is inserted into the insert stiffener slot 181, achieving the attachment between the insert portion 180 and the insert stiffener 240. Likewise, the insert stiffener 250 is inserted through the insert stiffener slot 211 in the insert portion 210 (not shown in FIG. 7) by flexing inwardly the flexible tab 293 and inserting the flexible tab 293 into the insert stiffener slot 211 to achieve attachment between the insert portion 210 and the insert stiffener 250. A full view of the left side 140 is seen in FIG. 8. An outer view of the left side 140 is seen in FIG. 9, wherein outer surface 169, outer surface 179, outer surface 229, and outer surface 249 can be seen Funnel stiffener 220 is seen inserted into the funnel stiffener slot 175 of funneling portion 170. The insert stiffener 240 is shown connected to the insert portion 180 by insertion into the insert stiffener slot 181. Although shown as separated elements in the current embodiment, in various embodiments each insert stiffener 240,250 may be integral and one continuous feature with each funnel stiffener 220,230.

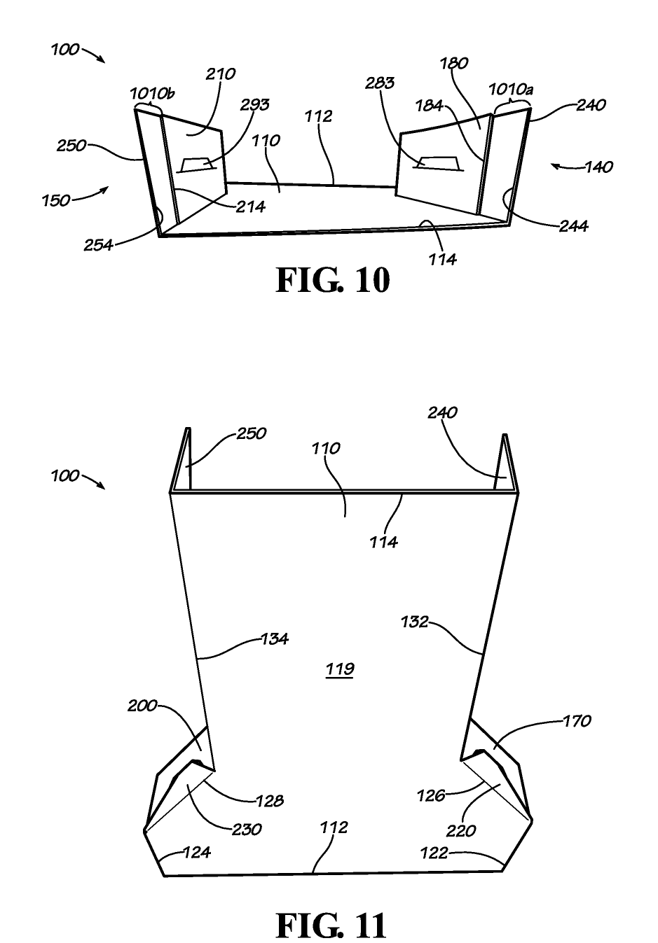

FIG. 10 is a view of the bag support 100 from the reverse view of FIG. 1 so that the back end 114 is in the foreground of the view and the front end 112 is in the background of the view. Because of the geometry of the left side 140, an offset 1010a exists between the back end 244 and the back end 184. Similarly, on the right side 150, an offset 1010b exists between the back end 254 and the back end 214. FIG. 11 shows the underside of the bag support 100, displaying the outer surface 119 of the base 110.

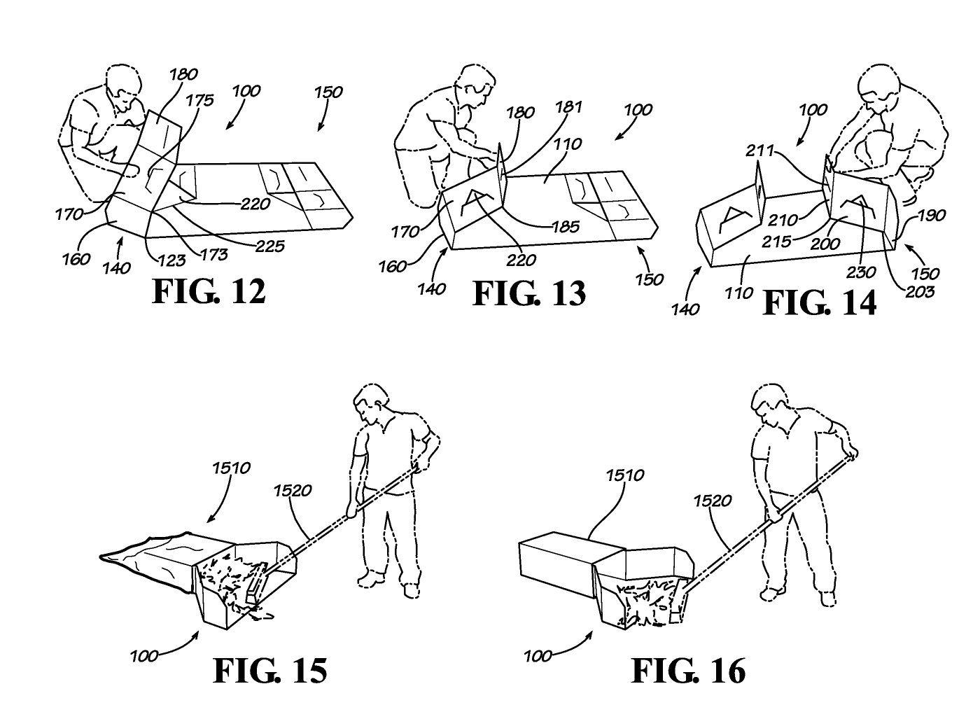

FIGS. 12-14 illustrate the assembly of the bag support 100 as shown and described more thoroughly with reference to FIGS. 3-8. In FIG. 12, the user has bent the left side 140 along bend line 123 and has bent the funneling portion 170 along bend line 173. The funnel stiffener 220 is shown bent along bend line 225 in preparation for insertion into funnel stiffener slot 175. FIG. 13 shows the user bending the insert portion 180 along bend line 185 and preparing to insert the insert stiffener 240 (not shown) into the insert stiffener slot 181. FIG. 14 shows that the left side 140 has been assembled. The user has bent the right side 150 along bend lines 203 and 215, and the user is preparing to insert the insert stiffener 250 (not shown) into the insert stiffener slot 211. FIGS. 15 and 16 show the bag support 100 in use to bag refuse, wherein a plastic refuse bag 1510 is used in one embodiment and a standard lawn refuse bag 1610—typically made of paper—is used in another embodiment. “Refuse,” as used in this disclosure, refers to any material sought to be discarded. The current embodiment displays the bag support as used for lawn refuse such as leaves, sticks, grass clippings, needles, and pine cones. However, various embodiments are applicable for use with all types of refuse. The refuse bag 1510 or 1610 is placed over the insert portion 180, 210 of the sides 140,150 and over the back end 114 of the base and the portion of the base 110 proximate the insert end portions 132,134. The user places the bag support 100 and refuse bag 1510,1610 assembly onto the ground, then uses a sweeping tool 1520 such as a broom, rake, or brush to sweep refuse through the bag support 100 and into the refuse bag 1510,1610. The user may discard the bag support 100 along with the refuse and refuse bag 1510,1610 in one embodiment. In another embodiment, the bag support 100 may be removed from the refuse bag 1510,1610 and stored for later use, and the refuse bag 1510,1610 may be discarded with the refuse.

Where materials are chosen for the elements of this assembly—particularly, corrugated cardboard—similar generally rigid material choices may also be used and would be obvious to one in the art, including corrugated cardboard or paper, linerboard, polymer, plastic, metal, alloy, wood, mesh, laminate, reinforced woven or nonwoven fabric, cellulose, composite, and combinations or mixtures of the foregoing, among others.

Assembly configurations present in this disclosure each represent one of many possible assembly configurations. One skilled in the art will understand obvious variations of this assembly configuration are included within this disclosure, including variations of steps, combinations of steps, and dissections of steps, among others. Although parts of the disclosed device may be described as integrated or separated, alterations to the shape and structure of the device may include alterations to the integrated or separated construction are intended to be included in this disclosure as an obvious variation.

1. A bag support comprising:
at least one base, the at least one base being about flat and extending the length of the bag support; and
two opposing sides, each side adaptable to be oriented about orthogonal with respect to the at least one base, each side including:
a flared portion, the flared portion being about flat;
a funneling portion, the funneling portion being about flat; and
an insert portion, the insert portion being about flat,
wherein a linear distance exists between the flared portions of each side,
wherein a linear distance exists between the insert portions of each side,
wherein the linear distance between the flared portions is greater than the linear distance between the insert portions, and
wherein the funneling portion of each side connects the flared portion of each side to the insert portion of each side and wherein each side is connected to each at least one base.

2. The bag support of claim 1, wherein the bag support is made of corrugated cardboard.

3. The bag support of claim 1, wherein at least one side is hingedly connected to at least one base.

4. The bag support of claim 3, wherein at least one hinged connection is a bend line.

5. The bag support of claim 1, wherein the flared portion of at least one side is hingedly connected to the funneling portion of at least one side.

6. The bag support of claim 5, wherein at least one hinged connection is a bend line.

7. The bag support of claim 1, wherein the funneling portion of at least one side is hingedly connected to the insert portion of at least one side.

8. The bag support of claim 7, wherein at least one hinged connection is a bend line.

9. A blank formable into a bag support comprising:
at least one base; and
at least two sides hingedly connected to the at least one base, each side including;
a flared portion;
a funneling portion; and
an insert portion;
wherein at least one hinged connection connects the flared portion, the funneling portion, and the insert portion;
wherein each of the at least two sides is adaptable to oppose at least one of the at least two sides by a connection to the at least one base, the flared portion, the funneling portion, and the insert portion formable into a funnel shape.

10. The blank of claim 9, wherein the blank is made of corrugated cardboard.

11. The blank of claim 9, wherein at least one hinged connection is a bend line.

12. The blank of claim 9, wherein at least one linear distance separates the flaring portions and at least one linear distance separates the insert portions, there being a largest distance of the at least one linear distances separating the flaring portions, there being a smallest distance of the at least one linear distances separating the insert portions, wherein the largest distance is larger than the smallest distance.

13. The blank of claim 9, wherein the at least two sides are adaptable to be oriented orthogonal to at least one base.

14. A method of manufacturing a blank formable into a bag support comprising:
receiving a blank;
forming bend lines in the blank to define a shape of a base;
cutting ends to define at least two sides;
cutting ends to define at least two stiffeners; and
forming bend lines in the at least two sides to define portions of the sides.

15. A method of assembling a bag support comprising:
providing at least two sides;
orienting at least one of the at least two side to oppose at least one of the at least two sides;
providing a base, wherein the at least two sides are connected to the base; and
forming the at least two sides into a funnel shape.

16. A method of using a bag support comprising:
receiving a blank formable into a bag support, the blank including at least one base and at least two sides;
orienting at least one of the at least two sides to oppose at least one of the at least two sides; and
forming the at least two sides into a funnel shape.

17. The method of claim 16, further comprising the steps of:
placing a refuse bag onto the funnel shape; and
inserting refuse into the bag.

18. The method of claim 17, further comprising the step of discarding the refuse bag and the bag support.

19. The method of claim 17, further comprising the steps of:
removing the refuse bag from the bag support; and
discarding the refuse bag.
